(19) United States
(12) Patent Application Publication
(10) Pub. No.: US 2015/0262152 A1
(43) Pub. Date: Sep. 17, 2015

(54) Network-Based Purchase and Distribution of Digital Media Items

(71) Applicant: Apple Inc., Cupertino, CA (US)

(72) Inventors: Max Muller, San Jose, CA (US); Wilfredo Sanchez, Santa Clara, CA (US); Ben Holt, Cupertino, CA (US)

(21) Appl. No.: 14/728,934

(22) Filed: Jun. 2, 2015

Related U.S. Application Data
(62) Division of application No. 11/126,703, filed on May 10, 2005, now abandoned.
Application No. 11/126,703 is a continuation-in-part of application No. 10/833,267, filed on Apr. 26, 2004, now Pat. No. 7,797,242.
Application No. 10/833,267 is a continuation-in-part of application No. 10/776,403, filed on Feb. 10, 2004, now abandoned.
(60) Provisional application No. 60/465,410, filed on Apr. 25, 2003.
(60) Provisional application No. 60/534,555, filed on Jan. 5, 2004.
(60) Provisional application No. 60/620,223, filed on Oct. 18, 2004.

(51) Int. Cl. G06Q 20/12

(52) U.S. Cl. CPC G06Q 20/1235; G06Q 2220/10

(57) ABSTRACT

Methods and systems for network-based purchase and distribution of media are disclosed. The purchase and distribution of media by these methods and systems are not only secure but also controlled. The media takes the form of a digital media item, which is assembled by a client application from one or more digital media item components, including at least one digital graphic associated with the media content contained in the digital media item. The digital media item components are stored on one or more server computers and are obtained by the client application, which requests, from a server computer, a media access response containing one or more pointers to digital media item components on one or more server computers. The assembled digital media item can then be encrypted for the purchaser's use and stored on the purchaser's machine. Thereafter, the purchaser can make use of the digital media item (e.g., play the digital media item).

### CROSS-REFERENCE TO RELATED APPLICATIONS

This application is a Divisional of U.S. patent application Ser. No. 11/126,703, filed May 10, 2005, and entitled “NETWORK-BASED PURCHASE AND DISTRIBUTION OF DIGITAL MEDIA ITEMS,” which is hereby incorporated by reference herein, which is a Continuation-in-Part of U.S. patent application Ser. No. 10/833,267, filed Apr. 26, 2004, and entitled “METHOD AND SYSTEM FOR NETWORK-BASED PURCHASE AND DISTRIBUTION OF MEDIA,” which is hereby incorporated by reference herein, which is a Continuation-In-Part of U.S. patent application Ser. No. 10/776,403, filed Feb. 10, 2004, and entitled “METHOD AND SYSTEM FOR NETWORK-BASED DISTRIBUTION OF MEDIA”, which is hereby incorporated by reference herein, which claims the benefit of: (a) U.S. Provisional Patent Application No. 60/465,410, filed Apr. 25, 2003, and entitled “METHOD AND SYSTEM FOR SECURE NETWORK-BASED DISTRIBUTION OF MEDIA”, which is hereby incorporated by reference herein; and (b) U.S. Provisional Patent Application No. 60/534,555, filed Jan. 5, 2004, and entitled “GRAPHICAL USER INTERFACE FOR BROWSING, SEARCHING AND PRESENTING MEDIA ITEMS”, which is hereby incorporated by reference herein.

This prior U.S. patent application Ser. No. 11/126,703 application also claims priority benefit of U.S. Provisional Patent Application No. 60/620,223, filed Oct. 18, 2004, and entitled “NETWORK-BASED PURCHASE AND DISTRIBUTION OF DIGITAL MEDIA ITEMS,” [Atty docket No. APL1P353P], which is hereby incorporated by reference herein.

This application is also related to: (i) U.S. patent application Ser. No. 10/832,812, filed Apr. 26, 2004, and entitled “METHOD AND SYSTEM FOR SECURE NETWORK-BASED DISTRIBUTION OF CONTENT” [Atty Docket No. APL1P269X1], which is hereby incorporated by reference herein, and (ii) U.S. patent application Ser. No. 10/832,984, filed Apr. 26, 2004, and entitled “GRAPHICAL USER INTERFACE FOR BROWSING, SEARCHING AND PRESENTING MEDIA ITEMS” [Atty docket No. APL1P277X1], which is hereby incorporated by reference herein.

### BACKGROUND

1. Field of the Invention

The present invention relates to media purchase and distribution and, more particularly, to the distribution of digital media items in a client-server environment.

2. Description of the Related Art

Traditionally, music has been purchased at music stores or music departments of larger stores. A consumer will visit the music store or department and manually browse for albums or compact discs (CDs) of interest. Often, the music in the music store or department is categorized by genre, and then indexed by artist. For example, genre can include rock, country, pop, soul, jazz, etc. After the consumer selects an album or CD of interest, the consumer proceeds to a check-out register to pay for the album or CD being purchased.

In recent years music delivery or distribution over the Internet has become popular. Due to the advances in efficient file formats, such as MP3 and MPEG4, the size of media files has become small enough to make their download via the Internet practical. Also, technological advances have led to higher-speed Internet connections and lower cost of memory. The combination of these advances make downloading media files, such as for music and videos, manageable and not too time consuming.

One popular approach to music distribution uses a centralized server for storage of the numerous songs that are available for download. The music industry typically has security concerns regarding the music that affect the manner music files can be used and distributed.

Besides the security concerns of the music industry, another problem is inefficient storage of digital media. For instance, the way in which music files are stored on a media server affects the space requirements for storing those music files. By way of example, in conventional music file storage systems, information that is common to many songs is stored in the header sections of every song (e.g., artist information or album information). Further, some music files contain small graphics files in their headers (e.g., gif files in the ID3 tags of an MP3 file or meta-tags in an MPEG-4 file)—which are typically album cover art or portraits of musical artists. Even though a typical graphics file is very small (often 250×250 pixels or smaller), a large number of graphics files are stored in a typical music file storage system—typically as many as one graphic file for each music file. The storage of multiple copies of files, such as the aforementioned graphics files, is redundant, inefficient and wasteful of storage resources. Additionally, if it is necessary to change the graphic for a group of songs, resource-expensive processing would need to be performed on each file in order to swap the old graphic for a new one. Moreover, in some cases, these problems apply to other types of digital media items as well, for instance, graphics associated with audio books, motion pictures, and music videos.

Thus, there is a need for methods of efficiently storing digital media items and corresponding embedded graphics files so as to optimize storage, updating, and transfer of digital media items.

### SUMMARY

Broadly speaking, the invention relates to network-based purchase and distribution of media. More specifically, the invention relates to the storing and transferring of digital media items (media files) from one or more source media servers by employing multiple files (digital media item components) rather than a single monolithic file, and the subsequent assembly (or construction) of complete digital media items at a destination client application using the multiple files (digital media file components). The purchase and distribution of digital media items are not only secure but also controlled. The security restricts access to media within digital media items during downloads as well as while stored at a server and/or client.

One aspect of the invention pertains to a system and method for transferring a digital media item and one or more digital graphics associated with the digital media item over a network as separate files. A client application, desirous for a particular digital media item, receives media access information from a server. The media access response may be formatted in any of several common file formats including, but not limited to, Extensible Markup Language (XML), Hypertext Markup Language (HTML), and plain text. In some embodiments, the media access information contains hyperlinks or file paths to a plurality of individual digital media item components, including at least one digital graphic. The digital media item components can include media content (e.g., audio, graphics, text, or video), media information (typically identifying information such as, for example, artist, author, publisher, title, publication date, etc.), licensing information (e.g., license keys), and user (licensee) account information (typically for use in digital rights management (DRM) schemes). In any case, the client application thereafter uses the media access information to retrieve the various digital media item components associated with the particular digital media item. The client application can then assemble complete digital media items from the retrieved digital media item components. The complete digital media items can then be stored on the client.

The invention can be implemented in numerous ways, including as a method, system, device, apparatus, graphical user interface, or computer readable medium. Several embodiments of the invention are discussed below.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a block diagram of a media purchase system according to one embodiment of the invention.

FIG. 1B is a flow diagram of a client-side media digital media item assembly process according to one embodiment of the invention.

FIG. 1C is a flow diagram of a server-side digital media item component identification process according to one embodiment of the invention.

FIG. 1D is a block diagram representation of an exemplary relational database containing various data tables and tables of pointers to digital media content according to one embodiment of the invention.

FIG. 1E is a block diagram of a digital media item, illustrating the distinction between digital media items and digital media content according to one embodiment of the invention.

FIGS. 2A and 2B are flow diagrams of media purchase processing according to one embodiment of the invention.

FIG. 3 is flow diagram of media commerce processing according to one embodiment of the invention.

FIG. 4 is a flow diagram of transaction completion processing according to one embodiment of the invention.

FIG. 5 is a flow diagram of media delivery processing according to one embodiment of the invention.

### DETAILED DESCRIPTION OF EMBODIMENTS OF THE INVENTION

The invention relates to network-based purchase and distribution of media. More specifically, the invention relates to the storing and transferring of digital media items (media files) from one or more source media servers by employing multiple files (digital media item components) rather than a single monolithic file, and the subsequent assembly (or construction) of complete digital media items at a destination client application using the multiple files (digital media file components). The purchase and distribution of digital media items are not only secure but also controlled. The security restricts access to media within digital media items during downloads as well as while stored at a server and/or client.

One aspect of the invention pertains to a system and method for transferring a digital media item and one or more digital graphics associated with the digital media item over a network as separate files. A client application, desirous for a particular digital media item, receives media access information from a server. The media access response may be formatted in any of several common file formats including, but not limited to, Extensible Markup Language (XML), Hypertext Markup Language (HTML), and plain text. In some embodiments, the media access information contains hyperlinks or file paths to a plurality of individual digital media item components, including at least one digital graphic. The digital media item components can include media content (e.g., audio, graphics, text, or video), media information (typically identifying information such as, for example, artist, author, publisher, title, publication date, etc.), licensing information (e.g., license keys), and user (licensee) account information (typically for use in digital rights management (DRM) schemes). In any case, the client application thereafter uses the media access information to retrieve the various digital media item components associated with the particular digital media item. The client application can then assemble complete digital media items from the retrieved digital media item components. The complete digital media items can then be stored on the client.

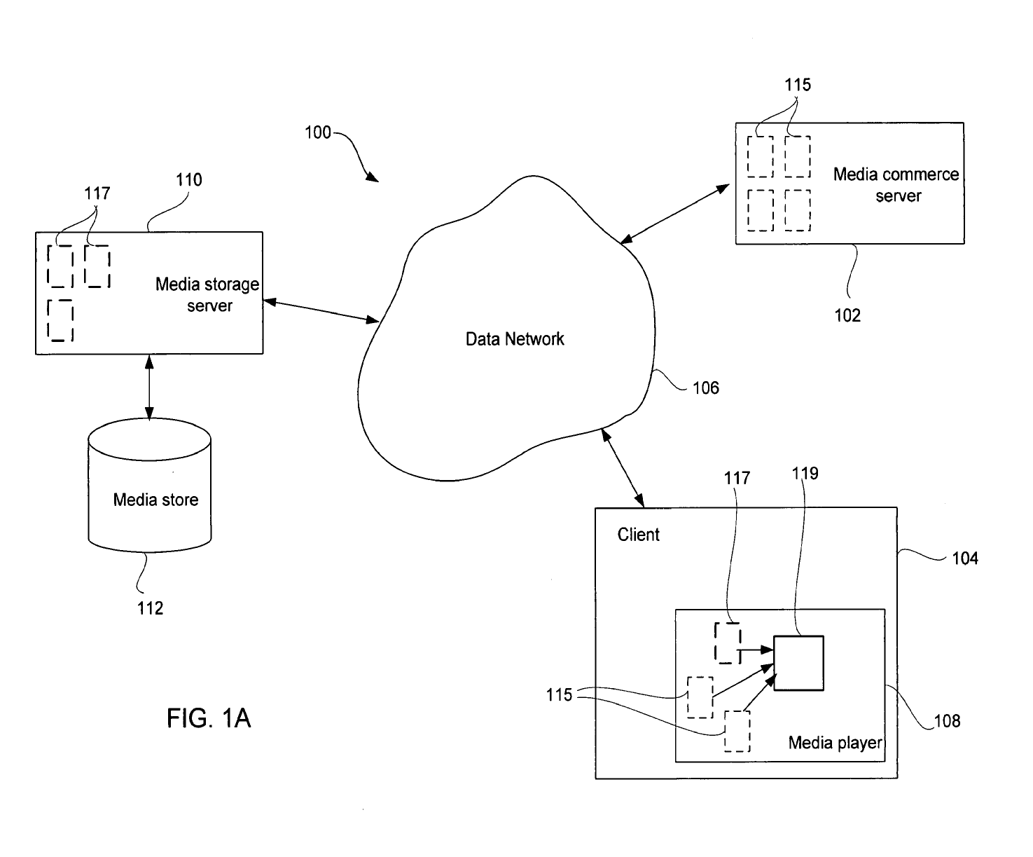

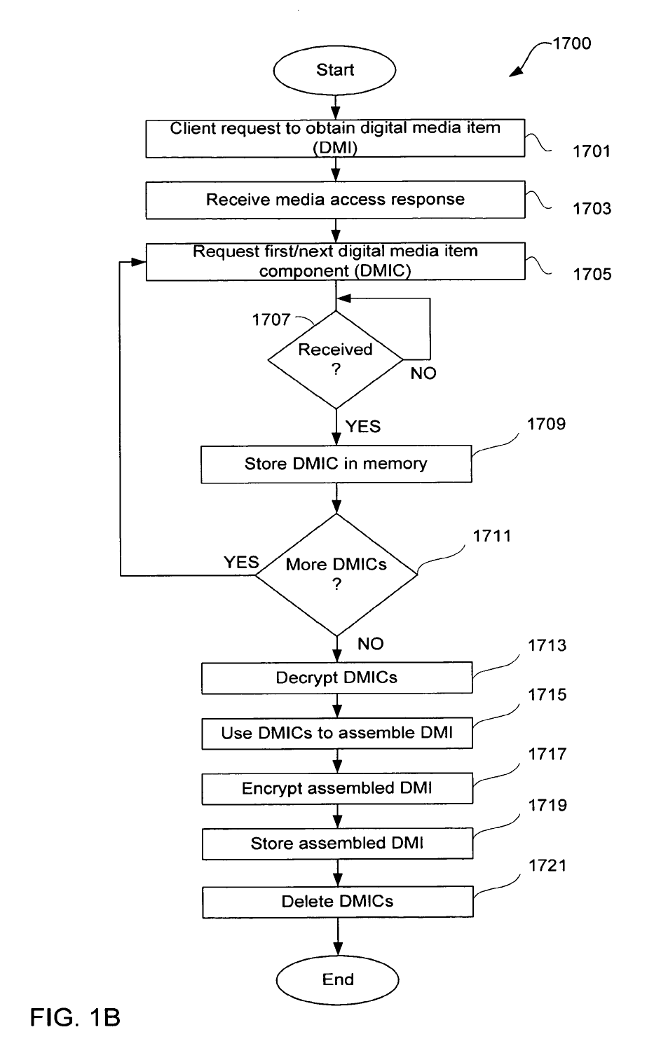

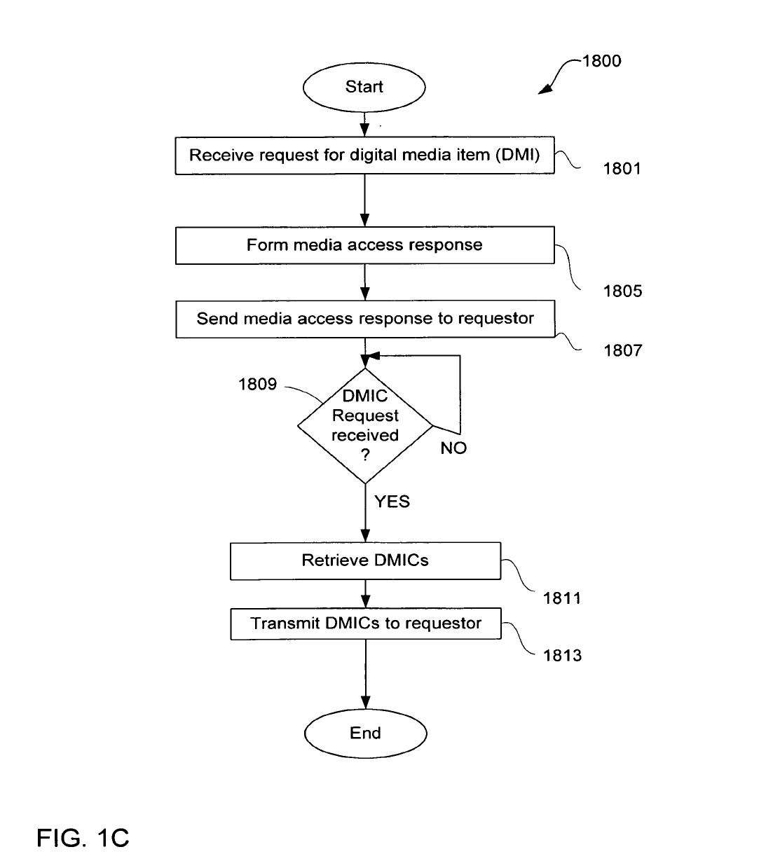

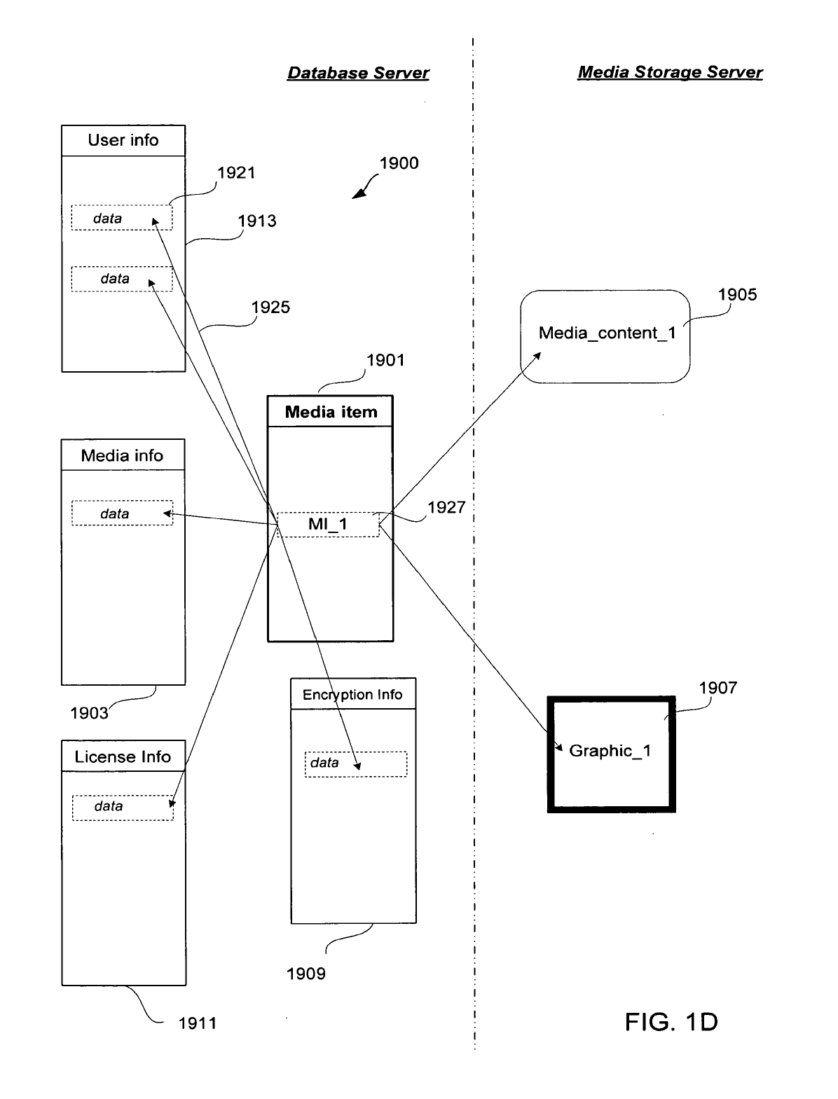

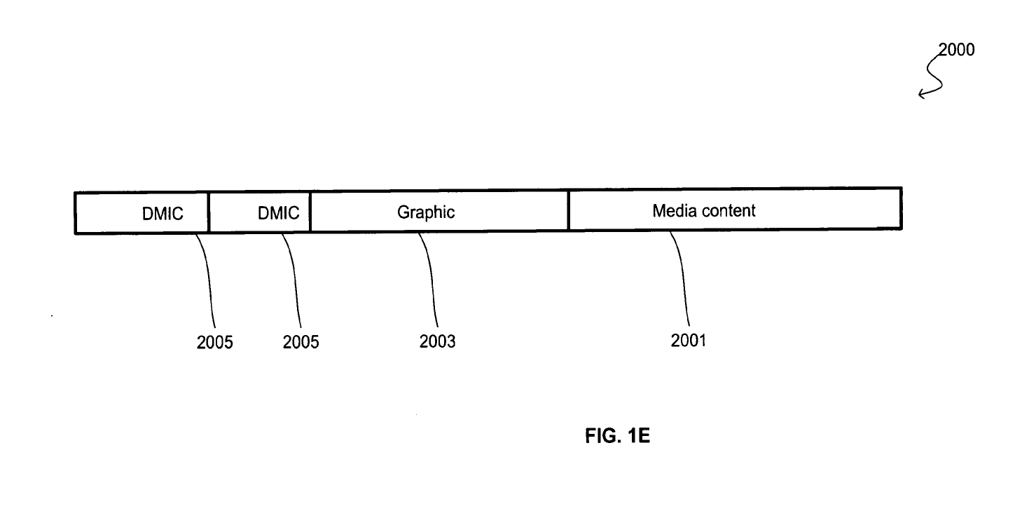

Embodiments of various aspects of the invention are discussed below with reference to FIGS. 1A-5. However, those skilled in the art will readily appreciate that the detailed description given herein with respect to these figures is for explanatory purposes as the invention extends beyond these limited embodiments.

One aspect of the invention pertains to a system and method for purchasing digital media items over a network. A potential purchaser can search and browse through numerous digital media items that are available for purchase. A potential purchaser can purchase a digital media item with great ease. Upon purchasing a digital media item, the digital media item can be downloaded in segments, e.g., media content, associated media information, and graphics can be downloaded over the network to the purchaser. Upon receiving the various segments of the digital media item, the digital media item can be assembled, encrypted, and stored on the purchaser's machine for the purchaser's use. The content for the digital media item is encrypted for the purchaser's use and stored on the purchaser's machine. Thereafter, the purchaser is permitted to make use of the digital media item (e.g., play the digital media item). However, the use of the digital media item can still be limited. For example, only up to a predetermined number user machines can be authorized to use the digital media item, or only up to a predetermined number of compact disc copies can be made of a grouping or collection of digital media items (e.g., a playlist).

FIG. 1A is a block diagram of a media purchase system 100 according to one embodiment of the invention. The media purchase system 100 includes a media commerce server 102. The media commerce server 102 coordinates review and/or purchase of digital media items through on-line transactions. In one embodiment, the media commerce server 102 also stores digital media item components 115 which are supplied to the clients 104 upon purchase of digital media items. On-line transactions to purchase digital media items is also referred to as electronic commerce (e-commerce). The media purchase system 100 also includes a client 104. Typically, the media purchase system 100 would include a plurality of different clients 104. Each client 104 includes a media player 108. The media player 108 is an application program that operates on the client 104, which is a computing device. In one embodiment, the application program is a software application that incorporates the ability to do one or more of the following: play, browse, organize, purchase, and transfer digital media items between devices, including portable media players (e.g., MP3 or MPEG4 players). Such a software application can be referred to as a media management application.

The client 104 can couple to the media commerce server 102 through a data network 106. Hence, any of the clients 104 can interact with the media commerce server 102 to review and/or purchase digital media items. In one embodiment, the data network 106 includes at least a portion of the Internet. The clients 104 can vary with application but generally are computing devices that have memory storage. Often, the clients 104 are personal computers or other computing devices that are capable of storing and presenting media to their users.

The media purchase system 100 also includes a media storage server 110 and a media store 112. The connections through the data network 106 among the media commerce server 102, the client 104 and the media storage server 110 can be through secure connections, such as Secure Sockets Layer (SSL). The media storage server 110 represents a remote storage server that couples to the data network 106. The media store 112 provides mass storage of some of numerous digital media item components 117. The digital media item components 117 are typically media content portions of the digital media items available for purchase via the media purchase system 100. For example, the digital media item components 117 can include digital media content files (e.g., electronic files containing audio, graphics, text, or video). In one embodiment, the digital media item components 117 are stored in an encrypted manner to prevent unauthorized copying or other usage. On the other hand, the digital media item components 115 are typically media information for the digital media items available for purchase via the media purchase system 100. Examples of media information include metadata descriptive of the media items, Digital Rights Management (DRM) information, and/or graphics. Once purchased, the digital media item components 117 can be accessed from the media store 112 over the data network 106 by way of the media storage server 110 and, combined at the media player 108 to form a complete digital media item 119. Note that, while FIG. 1A shows digital media item components 117 and other digital media item components 115 as residing on different servers, both may reside on the same server in some embodiments.

More particularly, the media purchase system 100 allows a user of the client 104 to utilize the media player 108 to browse, search or sort through a plurality of digital media items that can be purchased from the media commerce server 102. The media player 108 may also allow the user to preview the digital media items. In the event that the user of the media player 108 desires to purchase a particular digital media item, the user (via the media player 108) and the media commerce server 102 engage in an on-line commerce transaction in which the user pays for access rights to the particular digital media item. In this regard, the user is given access to digital media item components 115 (e.g., media information) and digital media item components 117 (e.g., digital media content files) corresponding to the particular digital media item.

FIG. 1E is an exemplary diagram of a digital media item 2000. The digital media item 2000 illustrates the distinction between digital media items and digital media content files according to one embodiment of the invention. The digital media item 2000 is illustrated as being divided into a plurality of segments, including digital media item content 2001, one or more digital graphics 2003 associated with the digital media item content 2001, and one or more other digital media item components 2005. In one embodiment, the digital media item content 2001 and the digital graphics 2003 are digital media item components 117, and the digital media item components 2005 are digital media item components 115.

Returning to the media purchase system 100 shown in FIG. 1A, the digital media content files 117 are stored in the media store 112 and retrieved via the media storage server 110. Hence, the media commerce server 102 need not burden its resources to completely deliver any of the digital media items that may be purchased to the client 104. Instead, on purchasing a particular digital media item, the media commerce server 102 sends a media access response to the media player 108 on the client 104. The media access response provides the media player 108 with information used to obtain access to the one or more digital media content files associated with the particular digital media item that has been purchased. The media access response, for example, can contain data pointers to an appropriate one or more of the digital media item components 117 (digital media content files) in the media store 112 as well as other one or more digital media item components 115. The one or more digital media item components 115 can include one or more of metadata (e.g., artist, author, publisher, title, publication date, etc.), licensing information (e.g., license keys), encryption or DRM data, and user (licensee) account information. In this embodiment, the media access response includes one or more digital media item components 115 and data pointers (e.g., path or URL) to one or more digital media item components 117. However, in another embodiment of the invention, the media access response can contain some or all of the digital media item components 117 embedded in the response, rather than pointers to the digital media item components 117.

The media access response can then be used by the media player 108 (and the client 104) to retrieve the digital media item components 117 for the particular digital media item by interacting with the media storage server 110 through the data network 106. In this regard, the media storage server 110 obtains all digital media item components 117 corresponding to the particular digital media item from the media store 112 and downloads such content through the data network 106 to the client 104. The media player 108 might also possibly retrieve other digital media item components 115 from the media commerce server 102. The particular digital media item (downloaded digital media item) can then be assembled (constructed) at the media player 108 (by merging the digital media content 117 and digital media item components 115) and stored on the client 104. In one embodiment, the downloaded digital media item is stored on the client 104 as received. In another embodiment, the downloaded digital media item is transcrypted from one encryption key to another encryption key before storage on the client 104. In still another embodiment, the downloaded digital media item is encrypted as received at the client 104 but is decrypted and then re-encrypted before storage on the client 104. In any case, once the downloaded digital media item is stored on the client 104, the media player 108 can present (e.g., play) the digital media item at the client 104. Further, the downloaded digital media item can be stored at the client 104 in an encrypted manner.

FIG. 1B is a flow diagram of a client-side digital media item assembly process 1700 according to one embodiment of the invention. The client-side digital media item assembly process 1700 involves using data and/or pointers to data contained in a media access response (corresponding to the digital media item components of FIG. 1A) to download a previously purchased (or otherwise authorized) digital media item from a digital media storage server, such as the media storage server 110 in FIG. 1A.

The client-side digital media item assembly process 1700 begins with a client request 1701 to obtain a digital media item (DMI) from a digital media storage server. The request 1701 pertains to a purchase request from an online media store or a download request that follows a completed purchase, or other authorized transaction, from the online media store.

The client receives 1703 a media access response. The media access response can include a list of digital media item components. As discussed above, digital media item components can include, but are not limited to, pointers to digital media content files and/or media information. The media information can include one or more of: media related information, licensing information, encryption or DRM data, and user account information. Some of the digital media item components can be contained in the list (embedded in-line) and thus do not need to be downloaded again to the client. Here, in one embodiment, the client uses the information contained in the media access response to retrieve the requested digital media item components. Here, the client makes a request 1705 for a first of the digital media item components in the media access response. A decision 1707 then determines if the requested digital media item component has been received. As noted above, some digital media item components will arrive with the media access response, and so will not need to be again requested. If the requested digital media item component is received, it is stored 1709 in memory. The memory, in the context of this embodiment, means a storage device, typically semiconductor memory, but includes hard drives, optical drives, or any other devices/components suitable for digital storage.

A decision 1711 then determines if there are more digital media item components (e.g., pointers to digital media item components) in the media access response that are to be requested. If so, the process 1700 returns to block 1705 and subsequent blocks to request and store a digital media item component. When the decision 1711 determines that all necessary digital media item components have been stored 1709 in memory, the digital media item components are decrypted 1713. Alternately, as described above in reference to FIG. 1A, the digital media item components are transcrypted from one encryption key to another encryption key before persistent storage on the client or encrypted as received at the client but decrypted and then re-encrypted before persistent storage on the client. The decrypted components are then assembled 1715 into an assembled digital media item, encrypted 1717, and subsequently stored 1719 in persistent memory (e.g., a hard drive or flash memory). Additionally, the process 1700 can then delete 1721, the digital media item components that were previously stored 1709.

FIG. 1C is a flow diagram of a server-side digital media item component identification process 1800 according to one embodiment of the invention. In one embodiment, a database or other suitable data structure contains information regarding storage location of digital media items and corresponding digital media item components. FIG. 1D is a block diagram representation of an exemplary database 1900 residing on a database server. The exemplary database 1900 contains tables of media information and tables of pointers to digital media content, suitable for use with some embodiments to the present invention. FIG. 1D also illustrates a media storage server suitable for storing digital media items being referenced by the exemplary database 1900.

The digital media item component identification process 1800 begins with a server computer (e.g., a file server) receiving 1801 a request for a digital media item. In one embodiment, the request comes from a client device, typically a client computer running a media player. Next, a database entry for the digital media item is looked up. The database entry contains different information, depending on the embodiment, but typically contains one or more pointers to the desired digital media content as well as pointers to database tables which contain other digital media item components, such as those discussed above.

Referring to FIG. 1D, a digital media item entry (‘MI_1’) 1927 in a digital media item table 1901, contains pointers 1925 to four other tables in the database—in this embodiment, a user information table 1913 containing user information data 1921, a media information table 1903, a license information table 1911, and an encryption information table 1909. It is understood that these four tables are exemplary, and other tables are possible. Additionally, the digital media item table 1901 contains pointers to digital media content 1905, for example, a song, video, and/or a graphic file 1907.

Returning to FIG. 1C, the digital media item component identification process 1800 continues by forming 1805 a media access response (e.g., a list of digital media item components) according to the information gathered in database 1900 (FIG. 1D). Next, the media access response is sent 1807 to the client device that requested the digital media item.

Having sent out a list of digital media item components, the digital media item component identification process 1800 then waits to receive 1809 a request for a digital media item component (DMIC). When such a request is received 1809, the first digital media item components are retrieved 1811 from database 1900 and transmitted 1813 to the requesting client device.

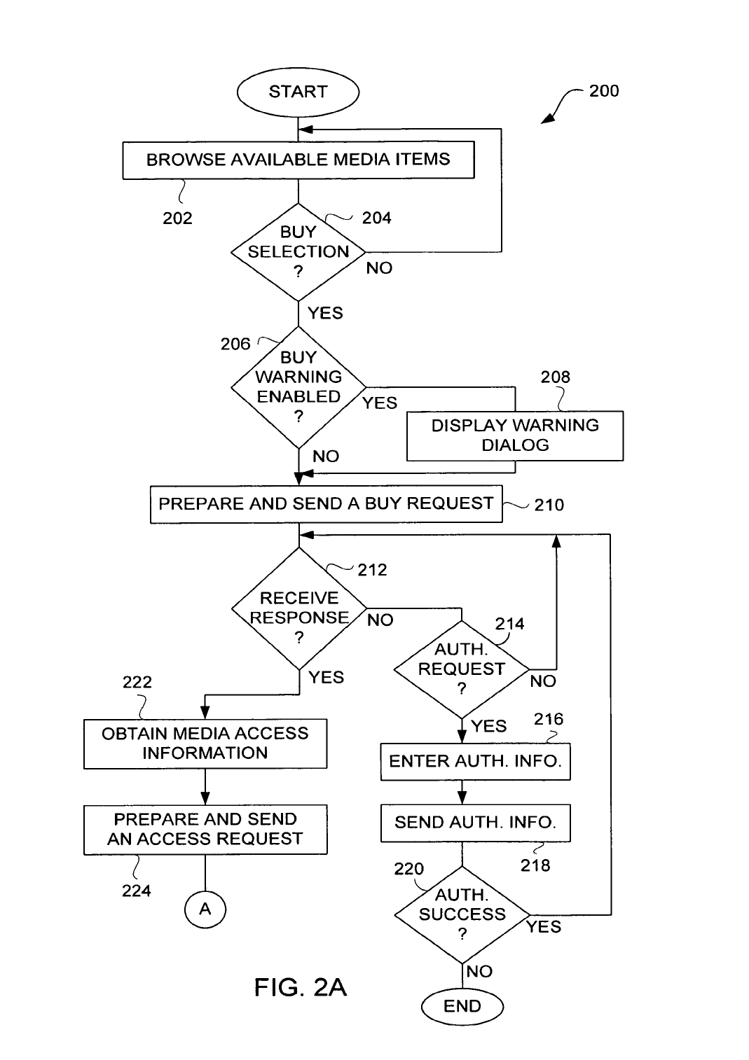

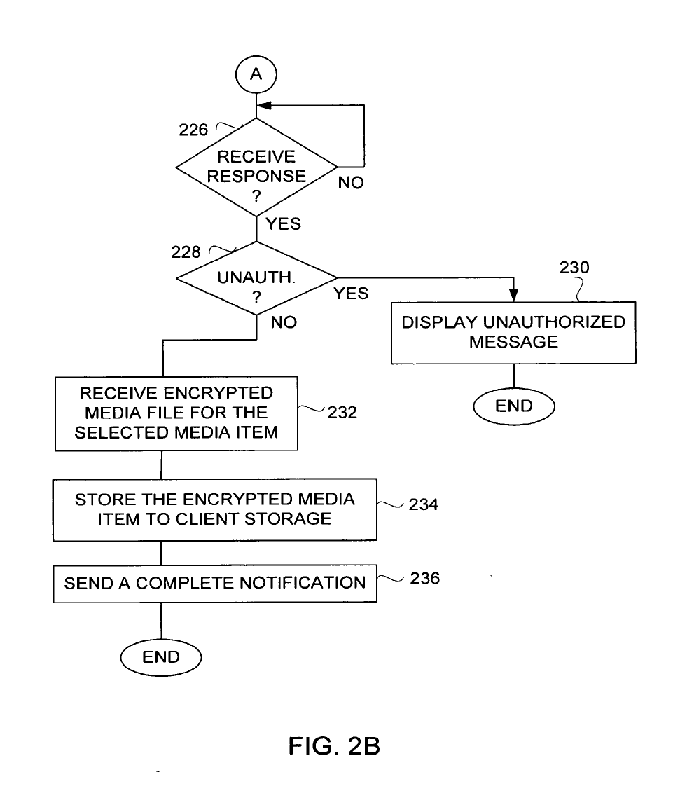

FIGS. 2A and 2B are flow diagrams of media purchase processing 200 according to one embodiment of the invention. The media purchase processing 200 is, for example, processing associated with a client device, such as with a media player of a media purchase system. The media player can, for example, be the media player 108 operating on the client 104 illustrated in FIG. 1A.

The media purchase processing 200 initially permits a user to browse 202 available digital media items. Typically, the media purchase system supports the purchase of a large number of digital media items. Hence, the ability to browse, sort and search the available digital media items is beneficial.

Next, a decision 204 determines whether a buy selection has been made. Here, in one embodiment, the buy selection is a single user interface action, such as one click of a button. The buy selection is with respect to a selected digital media item. The buy selection means that the user desires to purchase the selected digital media item. When the decision 204 determines that the buy selection has not yet been received, then the processing returns to repeat the operation 202 and subsequent operations. Once the decision 204 determines that a buy selection has been made, a decision 206 determines whether a buy warning is enabled. When the decision 206 determines that a buy warning is enabled, then a warning dialog is displayed 208 to the user of the media player. The warning dialog serves to warn the user that the buy transaction will be performed unless now canceled.

Following the operation 208, as well as directly following the decision 206 when the buy warning is not enabled, a buy request is prepared and sent 210 to a media server (e.g., the media commerce server 102) of the media purchase system. After the buy request has been prepared and sent 210, a decision 212 determines whether a response has been received. When the decision 212 determines that a response has not yet been received, a decision 214 determines whether an authentication request is instead received. When the decision 214 determines that an authentication request is not received, then the media purchase processing 200 returns to repeat the decision 212 and subsequent operations. On the other hand, when the decision 214 determines that an authentication is to be performed, then authorization information is entered 216. Here, the authorization information can be provided or entered 216 by the user associated with the media player. Subsequently, the authentication information that has been entered 216 is sent 218 to the media server.

Following the operation 218, a decision 220 determines whether the authentication has been successful. When the decision 220 determines that authentication has been successful, then the media purchase processing 200 returns to repeat the decision 212 and subsequent operations. On the other hand, when the decision 220 determines that authentication has been unsuccessful, the media purchase processing 200 is complete and ends.

Alternatively, when the decision 212 determines that a response to the buy request has been received, media access information is obtained 222. The response to the buy request includes at least the media access information. According to one embodiment, the media access information informs the media player as to where to locate the appropriate media file (more generally, digital media item components) that has been purchased as well as a download key and a security token. The download key is later used in decrypting the media file. The security token is used in verifying that the right to download the media file has been purchased. In one embodiment, the location of the appropriate media file resides on a media storage server, such as the media storage server 110. Typically, the media storage server is a centralized repository for media files. After the media access information has been obtained 222, an access request for the appropriate media file is prepared and sent 224. The access request is a request to the media storage server that stores the appropriate media file. In one example, the location of the appropriate media file can be designated by a Universal Resource Locator (URL).

Next, a decision 226 determines whether a response has been received. Here, the response, if received, pertains to the access request that was prepared and sent 224. When the decision 226 determines that a response to the access request has not yet been received, the media purchase processing 200 awaits such a response. Next, a decision 228 determines whether the user is authorized. Here, the response will either indicate that the request failed due to a lack of authorization or has succeeded and provides (e.g., downloads) the requested media file. When the decision 228 determines that the received response indicates failed authorization, then an unauthorized message is displayed 230 indicating that access to the requested media file is denied. Following the operation 230, when the user is not authorized, the media purchase processing 200 is complete and ends.

On the other hand, when the decision 228 determines that the user is authorized to receive the response, the encrypted media file for the selected digital media item is received 232. The encrypted media file can be received as part of the response or following the response. Then, the encrypted digital media item can be stored 234 to the client storage, and a complete notification can be sent 236. The complete notification can be sent 236 before or after the storage 234. At this point, the user of the client can thereafter present (e.g., play) the media content within the encrypted digital media item from the client storage after first decrypting the same using an appropriate key. The appropriate key is, for example, a user key that is associated with a user's account with the media purchase system 100. Optionally, after the encrypted digital media item is received 232 and before its storage to the client storage, the encryption imposed on the digital media item can be altered, such as by transcryption from one encryption key (e.g., download key) to another encryption key (e.g., user key) or by decryption from one encryption key (e.g., download key) followed by re-encryption with another encryption key (e.g., user key).

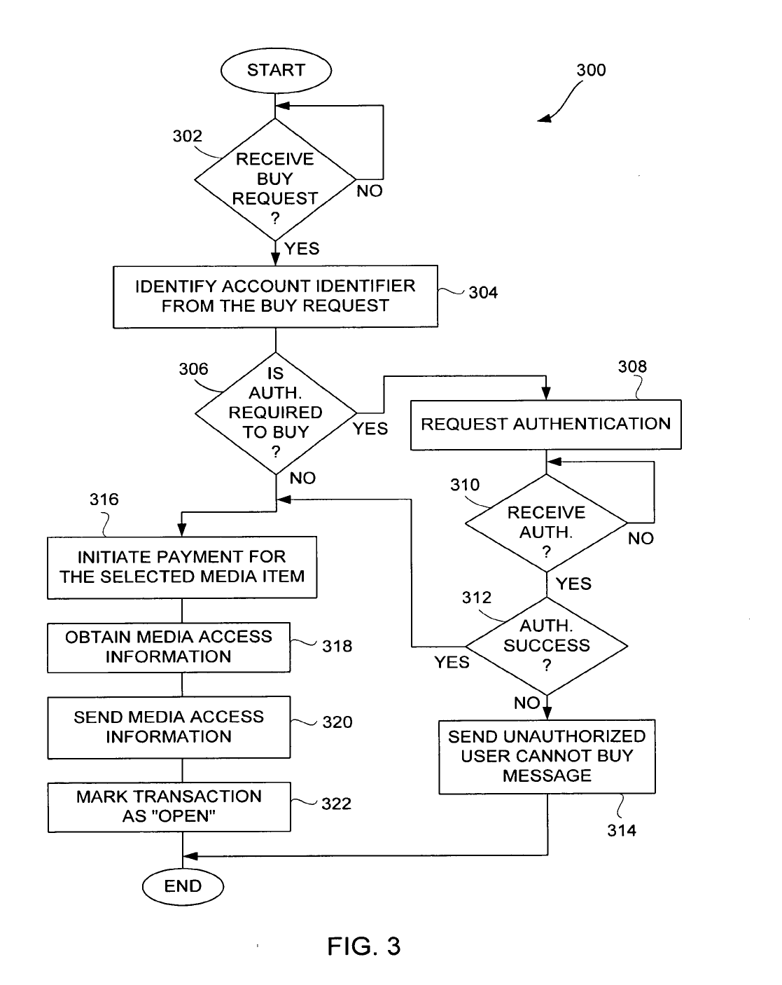

FIG. 3 is flow diagram of media commerce processing 300 according to one embodiment of the invention. The media commerce processing 300 is, for example, performed by a media commerce server, such as the media commerce server 102 illustrated in FIG. 1A.

The media commerce processing 300 begins with a decision 302 that determines whether a buy request has been received. When the decision 302 determines that a buy request has not yet been received, the media commerce processing 300 awaits such a request. On the other hand, when the decision 302 determines that a buy request has been received, the media commerce processing proceeds to process the buy request. In this regard, an account identifier is identified 304 from the buy request. Here, the buy request is sent by a client to the media commerce server on behalf of a user of the client (namely, a user of a media player operating on the client). In one embodiment, the buy request that is sent to the media commerce server includes not only an account identifier for the user of the client but also at least one digital media item identifier, media price, and a password token. The password token is random value (e.g., 128 bit string) that is different for every user. The media storage server provides the password token to the client as a result of successful authentication of the user. When the buy request includes a valid password token, the media commerce server can deem the client as properly authenticated.

Next, a decision 306 determines whether authentication is required prior to purchase of the digital media items. When the decision 306 determines that authentication is required, additional processing can be performed to determine whether such authentication exists. In one embodiment, the user's account or client can configure whether such authentication is required or can be overridden by the user. In one embodiment, the authentication is provided to help protect the user of the client (e.g., media player) from other unauthorized users who might access the media commerce server from the client after the user has successfully been authenticated to the media commerce server. The re-authentication is thus used to confirm that the particular user of the client (e.g., media player) is indeed the authorized user for such a system. In this regard, authentication is requested 308. Then a decision 310 determines whether an authentication response has been received. Once the decision 310 receives the authentication response, a decision 312 determines whether the authentication response is able to successfully authenticate the user. When the decision 312 determines that authentication has not been successful, a message indicating that an unauthorized user cannot buy digital media items is sent 314 to the client for display to the user.

On the other hand, when the decision 312 determines that authentication has been successful, then additional processing is performed to facilitate the purchase of the selected digital media item identified in the buy request. In this regard, payment for the selected digital media item is initiated 316. Here, according to one embodiment, the payment can be made by a credit card, and the initiation of such payment can verify the credit card's existence, but may or may not seek to post the charge at this time. After the payment for the selected digital media item has been initiated 316, media access information is obtained 318. The media access information is information that will enable the client (e.g., media player) to retrieve and then access the digital media content for the selected digital media item. The media access information, in one embodiment, includes a URL, a download key, and a security token. Next, the media access information is sent 320. Here, the media access information is sent from the media commerce server to the client, namely, the media player operating on the client. Then, the transaction associated with the purchase of the selected digital media item is marked 322 and remembered as being “open.” At this point, the transaction is not fully completed because the digital media content for the selected digital media item has not yet been received by the client. Following the operations 314 and 322, the media commerce processing 300 is complete and ends.

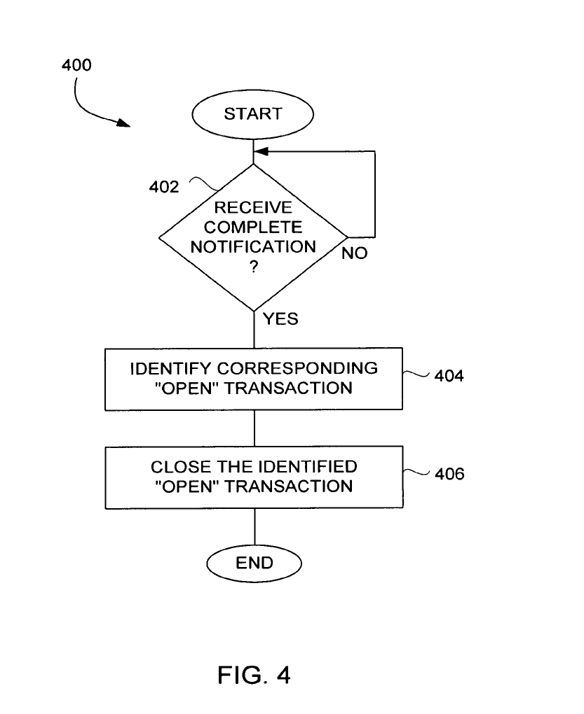

FIG. 4 is a flow diagram of transaction completion processing 400 according to one embodiment of the invention. The transaction completion processing 400 begins with a decision 402. The decision 402 determines whether a complete notification has been received. Here, a complete notification is a notification provided by a client to the media commerce server that indicates that a previously “open” transaction is now complete. Once the decision 402 determines that a complete notification has been received, the corresponding “open” transaction is identified 404. Then, the identified “open” transaction is closed 406. Once the identified “open” transaction is closed 406, the client is no longer able to download the digital media content for a purchased digital media item from a media storage server (FIG. 1A). In other words, the transaction is “closed” only after the client has confirmed receipt of the entire digital media content for the selected digital media item. By this approach, the client, after having paid for a particular digital media item, is guaranteed to receive a full copy of the digital media content even in the event the download process gets interrupted or dropped several times before it is successfully completed.

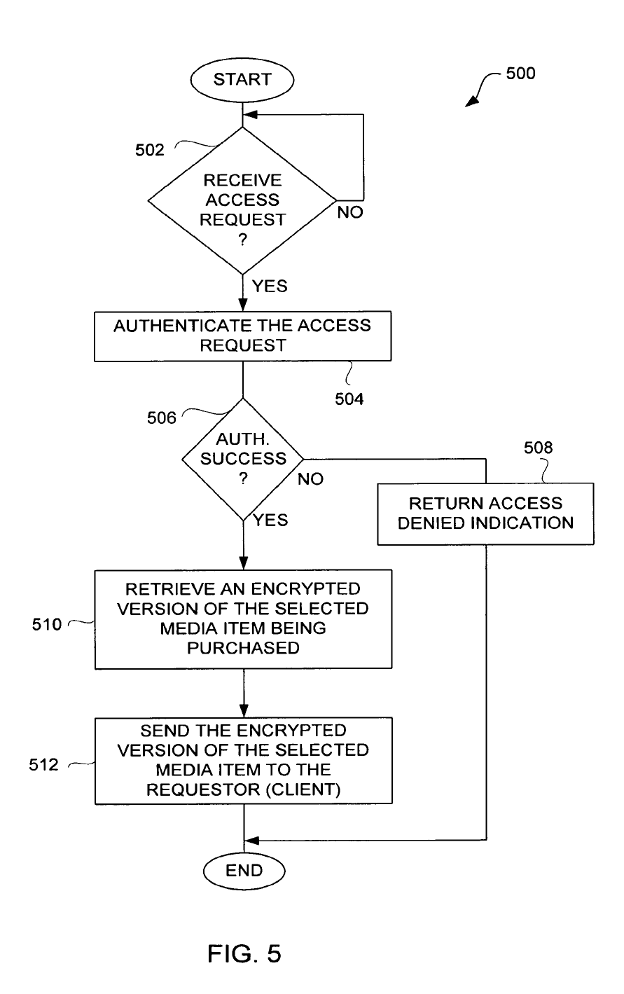

FIG. 5 is a flow diagram of media delivery processing 500 according to one embodiment of the invention. The media delivery processing 500 is, for example, performed by the media storage server 110 illustrated in FIG. 1A.

The media delivery processing 500 begins with a decision 502. The decision 502 determines whether an access request has been received. An access request is a request from a client to obtain the digital media content for one or more digital media items that are stored in a media store (e.g., media store 112) associated with the media storage server (e.g., media storage server 110). In one embodiment, the access request includes at least a URL for the selected digital media item and a security token from the client. When the decision 502 determines that an access request has been received, then the media delivery processing 500 is effectively invoked. In other words, once an access request has been received, the access request is authenticated 504. The authentication 504 involves the analysis of at least a portion of the access request to authenticate that the request is legitimate and from one that was authorized by the media commerce server. In one embodiment, a hash algorithm can be applied to the URL, a name of the media commerce server, a time of purchase. The result of the hash algorithm is then compared with the security token, which is the product of a complimentary hash algorithm performed at the media commerce server. A decision 506 then determines whether the authentication was successful. Here, in one embodiment, if the hashing algorithm approach is used, the result of the hash algorithm should match the security token within some tolerance set by a time limitation. For example, the tolerance due to time might permit the access request to remain authenticated for forty-eight (48) hours after purchase.

When the decision 506 determines that the authentication was not successful, then an access denied indication is returned 508. Here, the access request is denied and the client is so notified. On the other hand, when the decision 506 determines that the authentication was successful, then an encrypted version of the selected digital media item that has been purchased is retrieved 510. Here, the media storage server would retrieve the encrypted version of the selected digital media item from the media store. Then, the encrypted version of the selected digital media item is sent 512 to the requestor (client). In other words, the encrypted version of the selected digital media item is downloaded to the client that has requested the selected digital media item. Following the operations 508 and 512, the media delivery processing 500 is complete and ends.

The various aspects, features, embodiments or implementations of the invention described above can be used alone or in various combinations.

The digital media items can pertain to audio items (e.g., audio files or songs, such as for music or audiobooks), video items (e.g., video files or movies), or image items (e.g., photos).

The invention is preferably implemented by software, but can also be implemented in hardware or a combination of hardware and software. The invention can also be embodied as computer readable code on a computer readable medium. The computer readable medium is any data storage device that can store data, which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of an embodiment of the present invention is that, if a change needs to be made to a digital media item graphic (i.e., to replace it with a more current graphic or to add a graphic to a media item which did not previously have one), then the change can be made without having to do any processing of the media file associated with the graphic. The digital media item can be embodied as a list of pointers to digital media item components (i.e., a ‘virtual’ media item) until received and assembled by the client application (e.g., a media player) on the client computer.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A network-based media purchase system, comprising:
a first media storage server that stores digital media content;
a second media storage server that stores media item information;
a plurality of client media management applications (MMAs), each MMA being resident on a different client machine; and
a database resident on a database server, wherein the database contains at least media item information, a table of pointers to the digital media content residing on the first media storage server,
wherein the database server is capable of responding to a request from one of the client MMAs to download a digital media item by querying the database to create a media access response comprising media item information and one or more pointers to digital media content, and transmitting the media access response to the requesting client machine,
wherein the first media storage server is capable of responding to a request from a client MMA to download digital media content by sending the requested content to the client MMA,
wherein the second media storage server is capable of responding to a request from a client MMA to download media item information to the client MMA, and
wherein the client MMA is capable of assembling a digital media item by combining the digital media content from the first media storage server, and the media item information from the database server.

2. The system of claim 1, wherein one or more of the digital media content, the media information, and the digital media item are encrypted.

3. The system of claim 1, wherein the digital media item contains digital rights management (DRM) protection.

4. The system of claim 1, wherein the database contains a table of pointers to graphics associated with the digital media content.

5. The system of claim 4, wherein the digital media content being downloaded to the client MMA includes at least one digital graphic.

6. The system of claim 5, wherein, for the media access response, at least one of the one or more pointers to digital media content pertains to at least one digital graphic.
